(19) United States
(12) Patent Application Publication
(10) Pub. No.: US 2006/0100959 A1
(43) Pub. Date: May 11, 2006

(54) Methods and systems for implementing derivative transactions

(75) Inventor: Wayne Joseph Martin, Coral Springs, FL (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Englewood, CO (US)

(21) Appl. No.: 10/984,354

(22) Filed: Nov. 8, 2004

(51) Int. Cl. G06Q 40/00

(52) U.S. Cl. 705/39; 705/35

(57) ABSTRACT

Methods and systems are provided for executing a futures transaction for a customer. A record of a stored-value account is maintained on behalf of the customer at a host system. The record includes an identification of a level of value stored in the stored-value account. A request is received at the host system for approval for the customer to be a party to a contract having a defined future execution date or date range. The request specifies an amount of value due from the customer upon execution of the contract. An approval is recorded by modifying the record to include a specification of terms of the contract. A request for execution of the contract is received at the host system during the defined execution date or date range. The level of value stored in the stored-value account is reduced by the amount of value in response to receipt of the request for execution of the contract.

### BACKGROUND OF THE INVENTION

This application relates generally to derivative transactions. More specifically, this application relates to methods and systems for implementing derivative transactions.

As used herein, references to a “derivative transaction” are intended to refer to a transaction derived at least in part from another transaction that may be executed in the future. Execution of derivative transactions generally take the form of execution of an underlying contract between two parties. One example of a derivative transaction is a “futures transaction,” which is intended to refer herein to a transaction based on a futures contract between two parties specifying a date and certain terms for execution of the futures contract. Another example of a derivative transaction is an “option transaction,” which is intended to refer herein to a transaction based on an option contract between two parties securing the right of at least one of the parties to execute a defined transaction.

The derivatives market has developed a great deal of complexity and is most often associated with relatively sophisticated investment strategies. Relatively few individual consumers and small business make practical use of the underlying derivatives as a mechanism for managing costs in a predictable way. Yet this ability is a primary benefit of the derivatives themselves. The very complexity associated with managing derivatives has acted as a barrier to their practical use by individuals and small businesses. The result has been the development of system that is generally more concerned with the trade of derivatives and how profit may be generated by their purchase and sale, rather than their use as cost-management instruments.

There is accordingly a general need in the art for methods and systems for implementing derivative transactions that provide more convenience and ease of execution and use.

### BRIEF SUMMARY OF THE INVENTION

Embodiments of the invention thus provide methods and systems for implementing derivative transactions. In a first set of embodiments, a method is provided for executing a futures transaction for a customer. A record of a stored-value account is maintained on behalf of the customer at a host system. The record includes an identification of a level of value stored in the stored-value account. A request is received at the host system for approval for the customer to be a party to a contract having a defined future execution date or date range. The request specifies an amount of value due from the customer upon execution of the contract. An approval is recorded by modifying the record to include a specification of terms of the contract. A request for execution of the contract is received at the host system during the defined execution date or date range. The level of value stored in the stored-value account is reduced by the amount of value in response to receipt of the request for execution of the contract.

In some such embodiments, the approval is recorded by also designating a portion of the value stored in the stored-value account as frozen. For example, the portion of the value may be the amount of value. In some instances, a request is received at the host system for approval of a purchase transaction for a sale of goods from a seller to the customer. It is verified that a transaction amount for the purchase transaction is less than an unfrozen amount of value stored in the stored-value account. An approval for the purchase transaction is transmitted from the host system. The unfrozen amount of value is reduced by the transaction amount. In one embodiment, a first portion of the level of value is frozen and a second portion is not frozen, in which case the approval may be recorded by further designating part of the second portion as frozen.

The contract may be a contract for a sale of goods from a seller to the customer at a defined price. For instance, the goods may comprise a commodity. The amount of value may also be transmitted to an account maintained on behalf of the seller. In other instances, the level of value may be identified in terms of a first currency, with the contract being for purchase by the customer of an amount of a second currency at a defined exchange rate between the first and second currencies.

In one embodiment, value may be added to the stored-value account. A request is received at the host system to add value to the stored-value account, with the request being supported by additional identified value. The additional value is added to the level of value stored in the stored-value account.

In a second set of embodiments, a method is provided for executing an option transaction for a customer. A record of a stored-value account is maintained on behalf of the customer at a host system. The record includes an identification of a level of value stored in the stored-value account. A request is received at the host system for approval for the customer to execute an option contract to provide an option having a defined execution date or date range. The request specifies a first amount of value due from the customer. An approval is recorded by modifying the record to include a specification of terms of the option. The level of value is reduced by the amount of value. A request for execution of the option is received at the host system during the defined execution date or date range. The level of value is further reduced by a second amount of value specified by the terms of the option.

In some such embodiments, the option may be an option for a sale of goods from a seller to the customer at a defined price. For example, the goods may comprise a commodity. The second amount of value may be transmitted to an account maintained on behalf of the seller. In other instances, the level of value may be identified in terms of a first currency, with the option being for purchase by the customer of an amount of a second currency at a defined exchange rate between the first and second currencies.

In one embodiment, value may be added to the stored-value account. A request is received at the host system to add value to the stored-value account, with the request being supported by identified additional vale. The additional value is added to the level of value stored in the stored-value account.

Also, in some embodiments, a purchase transaction may additionally be executed. A request is received at the host system for approval of a purchase transaction for a sale of goods from a seller to the customer. It is verified that a transaction amount for the purchase transaction is less than the amount of value stored in the stored-value account. An approval for the purchase transaction is transmitted from the host system, and the amount of value is reduced by the transaction amount.

In a third set of embodiments, a method is provided for executing a purchase transaction. A record is maintained of a stored-value account on behalf of the customer at a host system. The record includes an identification of a level of value stored in the stored-value account and designates a portion of the value stored as frozen in support of a future contract to be executed by the customer. A request is received at the host system for approval of the purchase transaction. It is verified that a transaction amount for the purchase transaction is less than an unfrozen amount of value in the stored-value account. An approval for the purchase transaction is transmitted from the host system, and the unfrozen amount of value is reduced by the transaction amount.

In various embodiments, the method for executing a purchase transaction may be combined with the methods for executing a futures transaction and the methods for execution an option transaction. Also, the methods for executing a futures transaction and for execution an option transaction may be coupled in some embodiments. Furthermore, the methods of the present invention may be embodied in a computer-readable storage medium having a computer-readable program embodied therein for directing operation of a computer system. Such a computer system may include a communications system, a processor, and a storage device. The computer-readable program includes instructions for operating the computer system to implement the methods in accordance with the embodiments described above.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components. In some instances, a sublabel is associated with a reference numeral and follows a hyphen to denote one of multiple similar components. When reference is made to a reference numeral without specification to an existing sublabel, it is intended to refer to all such multiple similar components.

FIG. 1 is a block-diagram representation of an exemplary architecture for implementing methods of the invention in an embodiment;

FIG. 2 is a flow diagram that summarizes various methods for using stored-value tokens as part of the methods of the invention;

FIG. 3 is a schematic illustration of a physical structure of a host system on which methods of the invention may be embodied; and

FIGS. 4A-4C illustrate the status of certain information that may be maintained in implementing methods of the invention in an exemplary embodiment.

### DETAILED DESCRIPTION OF THE INVENTION

Embodiments of the invention provide methods and systems for handling derivative transactions by using techniques developed for implementing stored-value accounts. A typical stored value account operates by providing a host system that manages the stored-value account, maintaining records of such information as how much value exists in the account, where the value may be used, etc. Generally, a token is provided to an owner of the stored-value account, such as in the form of a magnetic-stripe card, although other tokens may be used, such as in the form of a chip card, rf device, and the like. When a transaction is to be executed using the value stored in the account, the customer provides the token at the time of the transaction, and information is read from the token to identify the account. This identifier is transmitted to the host system, which retrieves records of the amount of value available for use and confirms that the transaction may proceed. The host system debits the value applied during the transaction from the account and performs settlement functions to ensure that the other party to the transaction is credited with that value.

Embodiments of the invention use such an arrangement for the implementation of derivative transactions. For purposes of illustration, consider the case of a small business owner who has a generally predictable need for a commodity, such as gasoline. The business owner would like to take advantage of the periodically lower costs for the gasoline by buying greater volumes of it, but lacks storage capacity to hold significant volumes. A derivative would provide a convenient mechanism for the business owner to manage costs, such as by purchasing futures of gasoline at lower costs in accordance with the predicted needs. Similarly, the business owner might sometimes recognize the possibility of a higher-than-average short-term need for gasoline, in which case costs may be effectively managed through purchase of an option. Use of a stored-value arrangement significantly increases the ease of entering and managing such derivative-transaction arrangements.

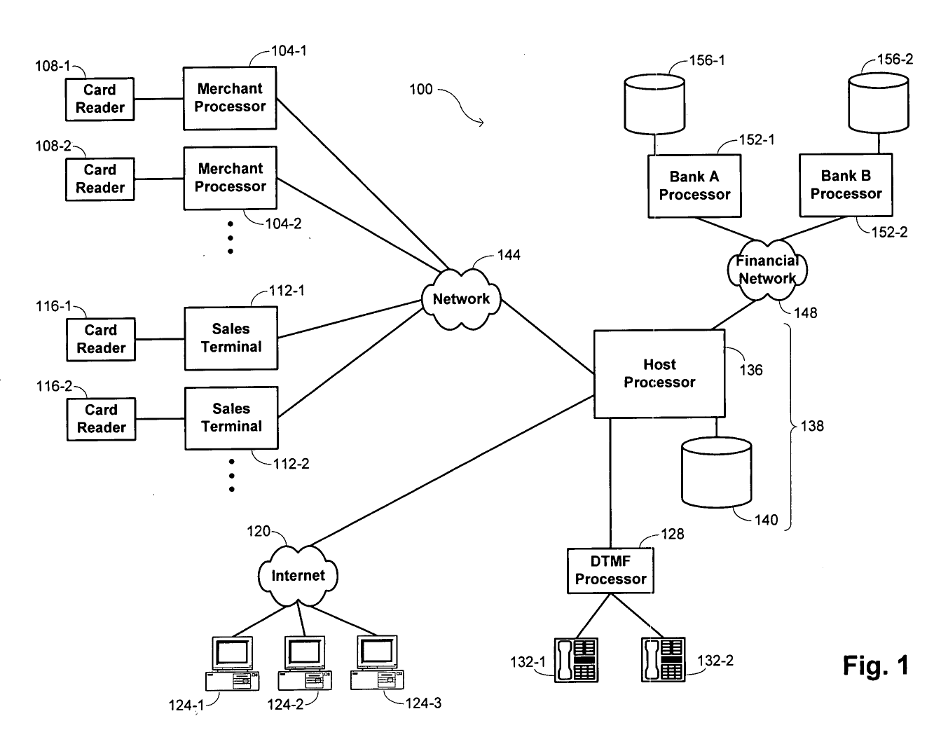

FIG. 1 provides a general overview of an architecture 100 that may be used in implementing embodiments of the invention. The host system 138 that coordinates the transfer of information and that maintains account records comprises a host processor 136 and a data store 140. The host system 138 is provided in communication with a number of other elements of the architecture through communications links with the host processor 136. The communications links may be electrical, optical, wireless, or any other type of communications link known to those of skill in the art.

Communications with point-of-sale devices, which may be used when a stored-value token is initially acquired or when a transaction involving the stored-value token is executed, may be routed through a network 144. Because of the sensitive financial nature of the communications, the network 144 usually comprises a secure network. The drawing distinguishes between merchant processors 104, which refer herein to parts of point-of-sale devices that are used in communicating information as part of executing a transaction, and sales terminals 112, which refer herein to parts of point-of-sale devices used when a stored-value token is initially provided to a customer. This distinction is largely conceptual since the same physical devices may usually be used for either or both functions. For purposes of illustration, the point-sale-devices are shown as including a card reader 108 or 116 in communication with the merchant processor 104 or sales terminal 112 for reading magnetic-stripe information in those embodiments where the stored-value token comprises a magnetic-stripe card. In other embodiments, other reading devices as appropriate for the type of token may be used instead. The point-of-sale devices may generally take a variety of different forms, including devices that may be operated by merchant clerks or may be self-operated by customers. Examples of point-of-sale devices that have varied functionality are described in the following commonly assigned applications, the entire disclosures of which are incorporated herein by reference for all purposes: U.S. Prov. Pat. Appl. No. 60/147,889, entitled “INTEGRATED POINT OF SALE DEVICE,” filed Aug. 9, 1999 by Randy J. Templeton et al.; U.S. patent application Ser. No. 09/634,901, entitled “POINT OF SALE PAYMENT SYSTEM,” filed Aug. 9, 2000 by Randy J. Templeton et al.; U.S. patent application Ser. No. 10/116,689, entitled “SYSTEMS AND METHODS FOR PERFORMING TRANSACTIONS AT A POINT-OF-SALE,” filed Apr. 3, 2002 by Earney Stoutenburg et al.; U.S. patent application Ser. No. 10/116,733, entitled “SYSTEMS AND METHODS FOR DEPLOYING A POINT-OF-SALE SYSTEM,” filed Apr. 3, 2002 by Eamey Stoutenburg et al.; U.S. patent application Ser. No. 10/116,686, entitled “SYSTEMS AND METHODS FOR UTILIZING A POINT-OF-SALE SYSTEM,” filed Apr. 3, 2002 by Earney Stoutenburg et al.; and U.S. patent application Ser. No. 10/116,735, entitled “SYSTEMS AND METHODS FOR CONFIGURING A POINT-OF-SALE SYSTEM,” filed Apr. 3, 2002 by Earney Stoutenburg.

The host processor 136 may also be provided in communication with one or more financial-institution processors 152, each of which functions as part of a system that maintains accounts on behalf of account holders on associated data stores 156. The financial institutions are identified as banks in the drawing, but may more generally be any type of financial institution, such as a trust company, and credit union, and the like. Communications between the host processor 136 and the financial-institution processors 152 take place over a financial network 148, which is generally provided as a secure network to protect the confidential and sensitive nature of the financial information that is routed.

In some instances, the host system 138 may additionally be provided in communication with other networks that permit customers to access information regarding the stored-value accounts that are maintained on the data store 140. This additional capability is generally of an administrative nature to provide functionality that permits customers to be active in the administration of these accounts. In some instances, more substantive capabilities may also be provided, enabling the customer to transfer funds between a stored-value account maintained by the host system 138 with an account maintained by one of the financial institutions. Other capabilities that might be provided include the ability to make bill payments with stored-value accounts through a network connection with the host system 138, and the like. Such additional networks may be provided in a number of different ways, such as through the use of a public network like the internet 120 that provides communications between the host processor 136 and a customer computers 124. Alternatively or additionally, the architecture 100 may support an interface to process touch-tone commands from customer telephones 132 through a dual-tone multiple-frequency (“DTMF”) processor 128. The DTMF processor 128 translates telephone touch tones to enable a customer to provide instructions through a telephone 132 and transmits audible responses to the customer. Still other mechanisms that may be used in different embodiments include voice-recognition processors, cable processors, and the like. The information-security issues related to the use of public networks like the internet may be different because of the greater risk of interception than over the private networks 144 and 148. A variety of techniques known to those of skill in the art may be used to provide enhanced security, including encryption of data transmitted over such public networks. Such techniques may be used with the transmission of information also over the private networks 144 and 148 to further provide strengthened security of the information.

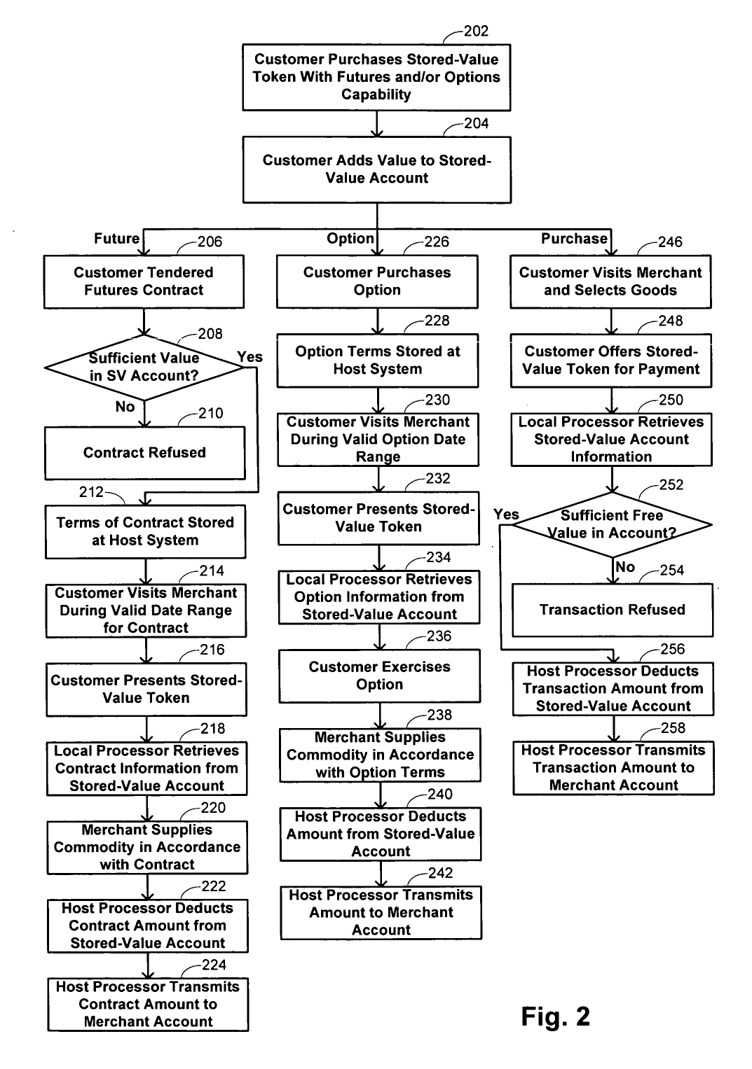

An overview of methods of the invention that may be implemented with an architecture like the one shown in FIG. 1 are summarized with the flow diagram of FIG. 2. For purposes of illustration, the flow diagram shows three different types of transactions that may be executed using the stored-value token, including derivative transactions that are illustrated for a futures transaction and for an option transaction, and also including a purchase transaction using stored value. The execution of a purchase transaction is illustrated explicitly since some embodiments may provide limitations on such a transaction as part of implementing certain types of derivative transactions. For instance, a portion of the stored value for an account may be frozen when the derivative includes a future contractual obligation to ensure that there is sufficient funds support for the contractual obligation. For instance, where the derivative transaction is a futures transaction obligating the customer to make a future purchase, the value needed for that purchase may be earmarked as inaccessible for use in purchase transactions. In contrast, where the derivative transaction is an option transaction, there is no future obligation on the part of the customer to make a purchase so no value is specifically earmarked.

These different features may be illustrated by considering the different paths through the flow diagram of FIG. 2. The flow diagram begins with the initial establishment of a customer's stored-value account, as indicated at block 202 with the purchase of a stored-value token equipped for use with derivative transactions. In some instances, a purchased token may have value that has been preloaded in the account, usually an amount that is equal to the purchase price of the token. In any event, the customer may be provided with the capability of adding value to the account, as indicated at block 204, to set a particular value for the account. Adding value may be performed in any of several different ways. For instance, the customer may use the administrative connections described in connection with FIG. 1 to supply a financial account from which value may be transferred to the stored-value account identified by the token. In such instances, the host processor 136 coordinates the value transfer in accordance with instructions from the customer and by using known techniques to identify the customer's authority to initiate debit instructions to a financial account held at a financial institution. Such techniques may include verification of a customer's personal identification number (“PIN”) associated with the account, and the like. Alternatively, the customer may present the token with a tendered value amount at a point-of-sale location, such as at one of the sales terminals 112 identified in FIG. 1. A clerk may swipe the card through the card reader 116 to extract the account identifier, which is transmitted to the host processor 136 to identify the account. The clerk may then accept tendered value from the customer, such as in the form of cash, a check, a credit card, etc. and key in the amount received so that the host system 138 updates the value associated with the identified account. Further ways of adding value may include similar processes that omit the involvement of the clerk by having the customer interact with a self-service device equipped with such devices as a cash collector, check reader, and the like to accept the tendered value.

Once a stored-value token has been provided to a customer and the corresponding account includes value, the token may be used in the execution of derivative transactions and purchase transactions. The left column of FIG. 2 illustrates the use of the token as part of a futures transaction, such as where the customer is tendered a futures contract at block 206. Such a contract typically includes terms specifying a date or date range when the contract is to be executed, the goods to be provided to the customer from a seller at the time of execution, and the amount of value to be provided by the customer to the seller at the time of execution. Because a specific amount of value will be needed to support the contract, a check is made at block 208 whether the stored-value account identified by the token has sufficient value. This may be done at any of the point-of-sale devices described in connection with FIG. 1 by extracting an identifier from the token and transmitting it to the host system 138 for retrieval of account information. If the account lacks sufficient value, the contract may be refused by the system at block 210.

If the account does have sufficient value, the terms of the contract are stored at the host system 138 at block 212. The storage of such terms may comprise freezing the amount of value required to support the contract so that they cannot be used as part of a purchase transaction or allocated to another futures transaction. At the time required for execution of the contract, the customer may visit the merchant, as noted at block 214, and present the stored-value token. In many instances, the location for execution of the contract may be different from the location where the terms were initially established, reflecting the fact that execution of the contract generally involves the delivery of a commodity or other goods to the customer. For instance, the terms of the contract established as part of executing the futures transaction may have taken place a sales terminal 112 located at a sales office while execution of the contract is performed with a merchant processor 104 located at a distribution center.

To execute the contract, the customer presents the stored-value token at block 216. The account identifier provided by the stored-value token is used to retrieve contract terms from the stored-value account at the host system 138 at block 218, which may be displayed to the parties on a monitor or other output device to confirm the contract terms. At block 220, the merchant supplies the commodity or other goods in accordance with the contract terms and at block 222 the host processor 136 deducts the contract amount from the stored-value account. The frozen-value amount is also reduced by the contract amount, but may not be reduced to zero if there were multiple derivative transactions executed that resulted in freezing of multiple amounts. The amount owed to the merchant as a result of executing the contract is transmitted to an account of the merchant, usually at a financial institution, at block 224. While in some instances, this may be done substantially immediately after execution of the contract, more usually it is performed as part of a settlement process that determines how changes in value handled by the host system 138 over some time period, such as a day, should be allocated among multiple merchants and financial institutions. Performing the settlement periodically in this fashion improves efficiency since the allocation of value amounts may be performed with a minimal set of transfers that defines the result of multiple transactions, rather than requiring a separate transfer for each of those transactions.

The middle column of FIG. 2 illustrates the use of the token as part of an option transaction, in which the customer purchases the right to execute a transaction without becoming obligated to do so. For example, an option transaction may be executed by a customer making payment of a certain amount in exchange for the right, which is then recorded by the system. Thus, at block 226, the customer purchases the option and the terms of the option are stored at the host system 138 at block 228. The terms of the option generally specify a date or range of dates when the option must be exercised, if at all, and specify the cost of a commodity or other goods to be supplied upon execution. If the customer fails to exercise the option before the end of the time period where he may, the recorded terms may simply be removed by the host system 138, at least from records of currently exercisable options.

In order for the customer to execute the option, he may visit the merchant at block 230 during the valid time period. As before, the execution of the option transaction may take place at a different physical location than where it is exercised, such as where the option transaction is executed with a sales terminal at a sales office and the option itself is executed with a merchant processor 104 located at a distribution center. Similar to the steps in executing a futures contract at this point, the customer presents the stored-value token at block 232 so that the local processor may retrieve the relevant option information from the stored-value account maintained by the host system 138 at block 234. In response to the customer exercising the option at block 236, the merchant supplies the commodity or other goods at block 238 in accordance with the option terms. The host processor deducts the amount to be charged from the stored-value account at block 240 and transmits that amount to the merchant account at block 242, usually as part of a periodic settlement process as described above.

The right column of FIG. 2 illustrates the use of the token as part of a purchase transaction, highlighting the effect on the availability of stored value that may be manifested as a result of enabling futures transactions to be executed. At block 246, the customer visits and merchant and selects goods for purchase. After the customer offers the stored-value token for payment at block 248, the local processor reads the account identifier from the token and uses it to retrieve the stored-value account information at block 250. If there is not sufficient free value in the account, as checked at block 252, then the purchase transaction is refused at block 254. There may be insufficient free value if the total value in the account is less than the transaction amount; alternatively, there may be insufficient free value even if the total value exceeds the transaction amount but with a portion of it frozen for use in supporting futures transactions or certain other derivative transactions. If the stored-value account has sufficient free value, the host processor deducts the transaction amount from the stored-value account at block 256 and transmits the transaction amount to a merchant account at block 258, usually as part of a periodic settlement process.

While the above discussion has focused on instances in which the future transaction is execution of a contract for a sale of goods or services, the future transaction may more generally comprise execution of any contract that requires payment by the customer. For example, in some embodiments, the future transaction comprises the purchase of a different currency by the customer, such as illustrated by an arrangement in which a customer arranges for the future purchase of 1000 euro for a cost of 1250 US dollars. Such an arrangement has the same advantages as other futures arrangements, permitting the customer to avoid future cost fluctuations, in this instance of the purchase of currency. Furthermore, in different embodiments, the transaction may be structured as a futures transaction in which the customer obligates himself to purchase the currency, or may be structured as an options transaction in which the customer secures the right to purchase a specified amount or range of currency at a specified rate.

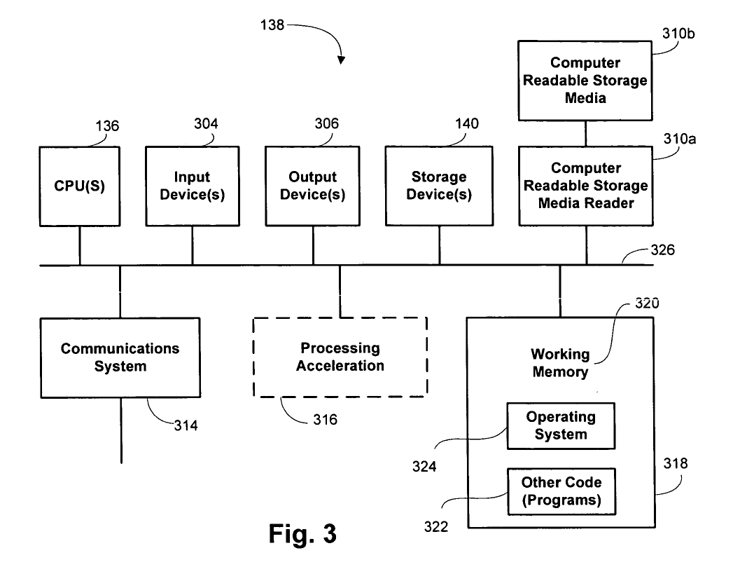

FIG. 3 provides a schematic illustration of a physical structure that may be used to implement the host system 138 in one embodiment. FIG. 3 broadly illustrates how individual system elements may be implemented in a separated or more integrated manner. The host system 138 is shown comprised of hardware elements that are electrically coupled via bus 326, including the host processor 136, an input device 304, an output device 306, the storage device 140, a computer-readable storage media reader 310a, a communications system 314, a processing acceleration unit 316 such as a DSP or special-purpose processor, and a memory 318. The computer-readable storage media reader 310a is further connected to a computer-readable storage medium 310b, the combination comprehensively representing remote, local, fixed, and/or removable storage devices plus storage media for temporarily and/or more permanently containing computer-readable information. The communications system 314 may comprise a wired, wireless, modem, and/or other type of interfacing connection and permits data to be exchanged with the networks 144, 148, 120, and 128 illustrated in FIG. 1 to implement embodiments as described.

The host system 138 also comprises software elements, shown as being currently located within working memory 320, including an operating system 324 and other code 322, such as a program designed to implement methods of the invention. It will be apparent to those skilled in the art that substantial variations may be made in accordance with specific requirements. For example, customized hardware might also be used and/or particular elements might be implemented in hardware, software (including portable software, such as applets), or both. Further, connection to other computing devices such as network input/output devices may be employed.

### EXAMPLE

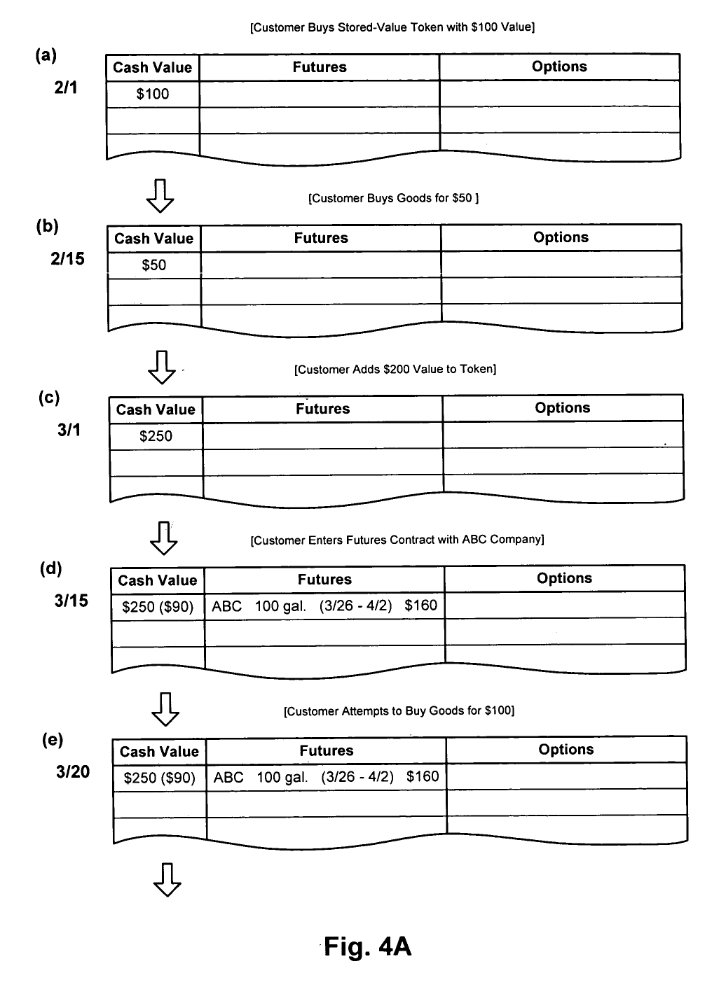

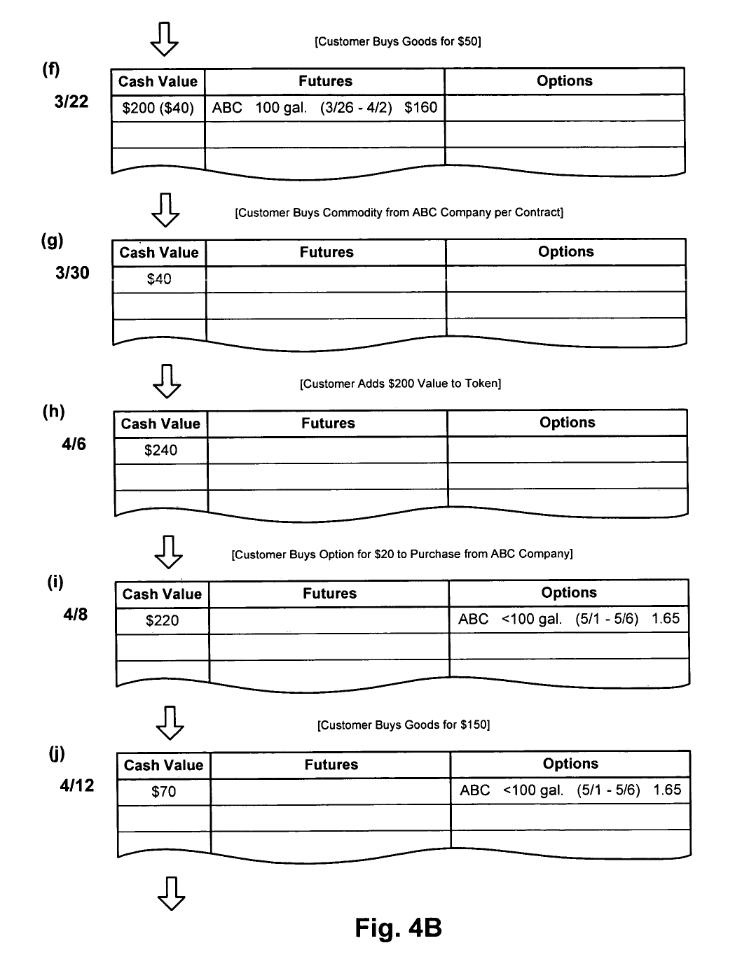

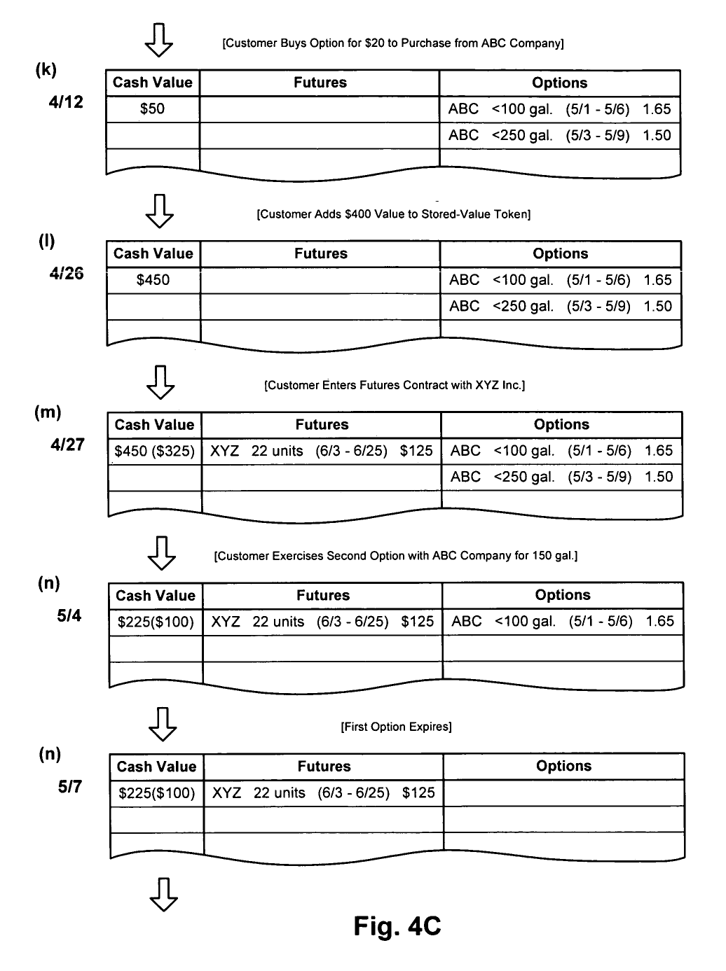

Methods of the invention as described generally in connection with FIG. 2 are illustrated with a specific example using the diagrams of FIGS. 4A-4C. These diagrams show an example of the type of information that may be maintained by the host system 138 for a particular account as the stored-value token is used by the customer to execute various derivative transactions and/or purchase transactions.

Part (a) of FIG. 4A shows an example of a record that may result when the customer initially purchases a stored-value token having a $100 value on February 1. Usually, the cost of the token to the customer is equal to its cash value, although in some instances the cost may be different. For instance, if tokens are provided as part of promotional programs, the initial cost to the customer may be less than the cash value; conversely, if tokens are sold as part of a fund-raising campaign, the initial cost to the customer may be greater than the cash value, with the excess value being donated to the fundraisers. The record for the account maintained on the data store 140 is shown to include a cash value of $100 and no other entries meaning that the value within the account may be used to support any transaction available with the stored-value token.

Part (b) of FIG. 4A shows the result of the customer using the stored-value card on February 15 to execute a purchase transaction for the purchase of goods for $50. The cash value in the account is thus reduced by that amount to $50. A subsequent addition of $200 of value by the customer on March 1 results in the record shown in part (c) of FIG. 4A, reflecting a cash value of $250. The operations shown in parts (a)-(c) of FIG. 4A thus illustrate traditional functionality of a reloadable stored-value account.

Part (d) of FIG. 4A shows the type of information that may be maintained when the card is used for execution of a derivative transaction, in this instance a futures transaction. The futures contract that underlies the executed futures transaction is a contract between the customer and ABC Company for the purchase of 100 gallons of gasoline at a cost of $160, the purchase to take place between March 26 and April 2. The futures transaction was approved because the available value in the account of $250 was greater than the contract amount of $160. Accordingly, the total cash value in the account is unchanged at $250, but the contract amount is frozen, leaving $90 of free value. The terms of the underlying contract are also recorded.

Because the free value is only $90, an attempt by the customer to execute a purchase transaction on March 20 is rejected, even though the total value in the account exceeds the transaction amount. The account record in part (e) of FIG. 4A is thus unchanged, still reflecting the same total and free value balances and maintaining a record of terms of the futures contract. Conversely, on March 22, when the customer executes a purchase transaction to buy goods for $50 using the stored-value token, the transaction is approved because the transaction amount is less than the free value. The record is thus updated in part (f) of FIG. 4B to reflect a reduction of $50 in both the total cash value stored in the account and in the amount of cash value that is free.

On March 30, i.e. within the time window for execution of the contract underlying the futures transaction, the customer visits a distribution center of the ABC company and executes the contract, purchasing the 100 gallons of gasoline for $160. The record maintained at the host system is initially used as described in connection with FIG. 2 to verify the terms of the contact, and is updated to reflect its execution. This is illustrated with part (g) of FIG. 4B, which shows both that the record of a future contract has been removed and that the value has been decremented by the contract amount. The remaining $40 of value is all free value.

When the customer adds an additional $200 of value to the account on April 6, the record is updated to reflect the new balance as shown in part (h) of FIG. 4B. The customer subsequently purchases an option from the ABC company on April 8 for the purchase of gasoline. The terms of the option are for an amount of gasoline less than 100 gallons at a rate of $1.65 per gallon, to be purchased between May 1 and May 6. The option transaction costs the customer $20 and ensures the availability of the terms as specified, but does not bind the customer to execute the option; if circumstances are such that the gasoline is not needed, or if the price drops in the interim, the customer may simply allow the option to expire. Accordingly, the updated record shown in part (i) of FIG. 4B shows that the terms of the option have been recorded and that the cash value has been decreased by the $20 payment made as part of executing the option transaction.

Because the option does not bind the customer, the value associated with the cost of executing the option, which may be up to $165, is not frozen and the entire $220 of value remains free. Thus, when the customer attempts to execute a purchase transaction on April 12 for $150, the transaction is approved even though the remaining value of $70 shown in part (j) of FIG. 4B is insufficient to cover the maximum potential option cost.

It is also possible for the system to record information regarding multiple derivatives. While generally there is no limit on the number of derivatives that may be accommodated at any time, the execution of derivative transactions being limited only by the need to have sufficient value to support binding derivatives like futures, it is possible in some embodiments for the system to limit the number of derivatives to some predetermined number or to some predetermined maximum value. An illustration of recording information regarding multiple derivatives is provided with part (k) of FIG. 4C, which shows how the record is updated when the customer executes a second option transaction to purchase a further option from ABC Company. In this instance, the option again costs $20, which is reflected be the reduction in cash-value balance for the stored-value account, and provides for the purchase of up to 250 gallons of gasoline at $1.50 per gallon between May 3 and May 9. The availability of such a second option with a lower price per gallon and a higher potential volume may reflect external changes in market conditions so that the expenditure of $20 by the customer to secure the second option may well result in a substantial savings overall.

Although the illustrations so far have shown examples of derivative transactions executed with a single company, the ABC Company, the system may permit derivative transactions to be executed with multiple different entities. Thus, the customer may wish to execute a futures transaction with XYZ Inc. and therefore adds $400 of value to the stored value account on April 26. This increase is reflected with the updated record shown in part (1) of FIG. 4C. On April 27, execution of the futures transaction to establish a futures contract for the purchase of 22 units at a cost of $125 between June 3 and June 25 is reflected in the updated record shown in part (m) of FIG. 4C. Because the futures contract binds the customer, the $125 of value is frozen so that the free value is identified in the figure as being $325.

On May 4, when the customer has the right to execute either or both of the options that have been recorded, he chooses to execute only the second option and to purchase 150 gallons of gasoline at $1.50 per gallon. The updated record in part (n) of FIG. 4C shows the corresponding reduction in total and free values by $225 and the removal of the information regarding the second option from the record. On May 7, when the first option expires, records related to it may simply be removed since the option has not been exercised, the removal of the record thereby preventing the option from being exercised outside the agreed time period.

Use of the stored-value token may proceed in this way indefinitely, with the customer adding value as desired and using the stored value to support purchase transactions and derivative transactions that the customer wishes to execute. In addition to records of the type illustrated in FIG. 4, the system may conveniently record historical track records of costs for the various commodities and other goods that are the subject of the derivative transactions. Such records may be valuable both to the customer and to the merchants who sell such goods.

Thus, having described several embodiments, it will be recognized by those of skill in the art that various modifications, alternative constructions, and equivalents may be used without departing from the spirit of the invention. Accordingly, the above description should not be taken as limiting the scope of the invention, which is defined in the following claims.

What is claimed is:

1. A method of executing a futures transaction for a customer, the method comprising:
maintaining a record of a stored-value account on behalf of the customer at a host system, the record including an identification of a level of value stored in the stored-value account;
receiving at the host system a request for approval for the customer to be a party to a contract having a defined future execution date or date range, the request specifying an amount of value due from the customer upon execution of the contract;
recording an approval by modifying the record to include a specification of terms of the contract;
receiving at the host system during the defined execution date or date range a request for execution of the contract; and
reducing the level of value stored in the stored-value account by the amount of value in response to receipt of the request for execution of the contract.

2. The method recited in claim 1 wherein recording the approval further comprises designating a portion of the value stored in the stored value account as frozen.

3. The method recited in claim 2 wherein the portion of the value is the amount of value.

4. The method recited in claim 2 further comprising:
receiving at the host system a request for approval of a purchase transaction for a sale of goods from a seller to the customer;
verifying that a transaction amount for the purchase transaction is less than an unfrozen amount of value stored in the stored-value account;
transmitting an approval for the purchase transaction from the host system; and
reducing the unfrozen amount of value by the transaction amount.

5. The method recited in claim 1 wherein the contract is a contract for a sale of goods from a seller to the customer at a defined price.

6. The method recited in claim 5 wherein the goods comprise a commodity.

7. The method recited in claim 5 further comprising transmitting the amount of value to an account maintained on behalf of the seller.

8. The method recited in claim 1 wherein:
the level of value is identified in terms of a first currency; and
the contract is for purchase by the customer of an amount of a second currency at a defined exchange rate between the first and second currencies.

9. The method recited in claim 1 wherein recording the approval further comprises transmitting an acknowledgment of the approval to the customer.

10. The method recited in claim 1 further comprising:
receiving a request at the host system to add value to the stored-value account, the request being supported by identified additional value; and
adding the additional value to the level of value stored in the stored-value account.

11. The method recited in claim 1 wherein:
a first portion of the level of value is frozen and a second portion of the level of value is not frozen; and
recording the approval further comprises designating part of the second portion as frozen.

12. The method recited in claim 1 further comprising:
receiving at the host system a request for approval for the customer to execute an option contract to provide an option having a second defined execution date or date range, the request for approval for the customer to execute the option contract specifying a second amount of value due from the customer;
recording a second approval by modifying the record to include a specification of terms of the option;
reducing the level of value by the second amount of value;
receiving at the host system during the second defined execution date or date range a request for execution of the option; and
further reducing the level of value by a third amount of value specified by the terms of the option.

13. A computer system comprising:
a communications system;
a storage device;
a processor in communication with the communications system and the storage device; and
a memory coupled with the processor, the memory comprising a computer-readable storage medium having a computer-readable program embodied therein for directing operation of the computer system to execute a futures transaction for a customer, the computer-readable program including instructions form implementing the method recited in claim 1.

14. A method of executing an option transaction for a customer, the method comprising:
maintaining a record of a stored-value account on behalf of the customer at a host system, the record including an identification of a level of value stored in the stored-value account;
receiving at the host system a request for approval for the customer to execute an option contract to provide an option having a defined execution date or date range, the request specifying a first amount of value due from the customer;
recording an approval by modifying the record to include a specification of terms of the option;
reducing the level of value by the amount of value;
receiving at the host system during the defined execution date or date range a request for execution of the option; and
further reducing the level of value by a second amount of value specified by the terms of the option.

15. The method recited in claim 14 wherein the option is an option for a sale of goods from a seller to the customer at a defined price.

16. The method recited in claim 15 wherein the goods comprise a commodity.

17. The method recited in claim 15 further comprising transmitting the second amount of value to an account maintained on behalf of the seller.

18. The method recited in claim 14 wherein:
the level of value is identified in terms of a first currency; and
the option is for purchase by the customer of an amount of a second currency at a defined exchange rate between the first and second currencies.

19. The method recited in claim 14 wherein recording the approval further comprises transmitting an acknowledgment of the approval to the customer.

20. The method recited in claim 14 further comprising:
receiving a request at the host system to add value to the stored-value account, the request being supported by identified additional value; and
adding the additional value to the level of value stored in the stored-value account.

21. The method recited in claim 14 further comprising:
receiving at the host system a request for approval of a purchase transaction for a sale of goods from a seller to the customer;
verifying that a transaction amount for the purchase transaction is less than the amount of value stored in the stored-value account;
transmitting an approval for the purchase transaction from the host system; and
reducing the amount of value by the transaction amount.

22. The method recited in claim 14 further comprising:
receiving at the host system a request for approval for the customer to be a party to a contract having a defined future second execution date or date range, the request for approval for the customer to be a party to the contract specifying a third amount of value due from the customer upon execution of the contract;
recording a second approval by modifying the record to include a specification of terms of the contract;
receiving at the host system during the second defined execution date or date range a request for execution of the contract; and
further reducing the level of value by the third amount in response to receipt of the request for execution of the contract.

23. A computer system comprising:
a communications system;
a storage device;
a processor in communication with the communications system and the storage device, and
a memory coupled with the processor, the memory comprising a computer-readable storage medium having a computer-readable program embodied therein for directing operation of the computer system to execute an option transaction for a customer, the computer-readable program including instructions form implementing the method recited in claim 14.

24. A method for executing a purchase transaction for a purchase of goods from a seller to a customer, the method comprising:
maintaining a record of a stored-value account on behalf of the customer at a host system, the record including an identification of a level of value stored in the stored-value account and designating a portion of the value stored as frozen in support of a future contract to be executed by the customer;
receiving at the host system a request for approval of the purchase transaction;
verifying that a transaction amount for the purchase transaction is less than an unfrozen amount of value in the stored-value account;
transmitting an approval for the purchase transaction from the host system; and
reducing the unfrozen amount of value by the transaction amount.

25. The method recited in claim 24 wherein the record further includes a specification of terms of the contract, the terms including a defined future execution date or date range, the method further comprising:
receiving at the host system during the defined execution date or date range a request for execution of the contract; and
reducing the level of value stored in the stored-value account by the amount of value in response to receipt of the request for execution of the contract.

26. The method recited in claim 24 further comprising:
receiving at the host system a request for approval for the customer to be a party to a second contract having a defined future execution date or date range, the request for approval for the customer to be a party to the second contract specifying a second amount of value due from the customer upon execution of the second contract;
verifying that the second amount of value is less than the unfrozen amount of value in the stored-value account;
recording a second approval by modifying the record to include a specification of terms of the second contract and designating a portion of the unfrozen amount of value equal to the second amount as frozen;
receiving at the host system during the defined execution date or date range a request for execution of the second contract; and
reducing the level of value and the portion designated as frozen by the second amount in response to receipt of the request for execution of the second contract.

27. The method recited in claim 24 further comprising:
receiving at the host system a request for approval for the customer to execute an option contract to provide an option having a defined execution date or date range, the request for approval for the customer to execute the option contract specifying a second amount of value due from the customer;
verifying that the second amount of value is less than the unfrozen amount of value in the stored-value account;
recording a second approval by modifying the record to include a specification of terms of the option;
reducing the level of value and by the second amount of value;
receiving at the host system during the defined execution date or date range a request for execution of the option; and
further reducing the level of value by a third amount of value specified by the terms of the option.

28. A computer system comprising:
a communications system;
a storage device;
a processor in communication with the communications system and the storage device; and
a memory coupled with the processor, the memory comprising a computer-readable storage medium having a computer-readable program embodied therein for directing operation of the computer system to execute a purchase transaction for a purchase of goods from a seller to a customer, the computer-readable program including instructions form implementing the method recited in claim 24.
